(19) United States
(12) Patent Application Publication
(10) Pub. No.: US 2026/0161189 A1
(43) Pub. Date: Jun. 11, 2026

(54) FORCE BALANCED DUAL VALVE SYSTEMS FOR STEERING TOOL AND METHODS OF USING THE SAME

(71) Applicant: Baker Hughes Oilfield Operations LLC, HOUSTON, TX (US)

(72) Inventors: Bastian SAUTHOFF, Hannover (DE); Thomas WETTMARSHAUSEN, Hannover (DE)

(73) Assignee: Baker Hughes Oilfield Operations LLC, HOUSTON, TX (US)

(21) Appl. No.: 19/410,852

(22) Filed: Dec. 5, 2025

Related U.S. Application Data
(60) Provisional application No. 63/728,551, filed on Dec. 5, 2024.
(60) Provisional application No. 63/728,557, filed on Dec. 5, 2024.
(60) Provisional application No. 63/728,561, filed on Dec. 5, 2024.

(51) Int. Cl. G05D 16/00; E21B 7/04; E21B 47/18

(52) U.S. Cl. CPC G05D 16/028; E21B 7/04; E21B 47/18

(57) ABSTRACT

A force balanced valve apparatus for downhole steering tools that includes a valve actuator (214), first and second valve bodies (218, 220), an inverse travel linkage (230), and a flow twisting section (208) for pressure balancing. The flow twisting section reorients fluid flow paths by approximately 180°from an uphole valve section (207) of the apparatus to a downhole steering pressure generation section (210). Hydraulic forces are balanced across the valve apparatus are balanced by force balancing pistons (222, 224) responsive to pressures in the steering pressure generation section. The force balanced valve apparatus may generate steering pressure differentials for directional drilling and mud pulse telemetry by modulating fluid flow.

### CROSS-REFERENCE TO RELATED APPLICATIONS

This application claims priority from U.S. Provisional Application No. 63/728,551 filed Dec. 5, 2024, and titled “MUD HYDRAULIC OPERATED ROTARY STEERABLE SYSTEM,” from U.S. Provisional Application No. 63/728,557 filed Dec. 5, 2024, and titled “COMBINED ROTARY STEERABLE AND MUD PULSE TELEMETRY TOOL,” and from U.S. Provisional Application No. 63/728,561 filed Dec. 5, 2024, and titled “FORCE BALANCED DUAL VALVE PULSER SYSTEM,” each of which are incorporated by reference herein in their entirety.

### BACKGROUND

### Field of the Disclosure

The present disclosure relates generally to downhole tools and, more particularly, to steerable tools with force balanced dual valves.

### Description of the Related Art

Drilling systems having earth boring drill bits on an end of a drill string are commonly used in the oil and gas industry for creating wells drilled into hydrocarbon bearing geologic formations. The drill bit is rotationally affixed to the drill string in some drilling systems. A rotary drilling system has a drill string having a bottom hole assembly (BHA) connected to the drill bit which is rotatably driven from a drilling rig on the surface having either a top drive or rotary table to rotate the drill string and the drill bit to bore through the subterranean formation. In other varieties of drilling systems, the drill bit rotates with respect to the drill string. The drill bit may be driven downhole by a downhole drive, as for example a mud motor. A downhole mud motor is sometimes employed for rotating the drill bit while the drill string does not rotate or rotates at a different speed.

During rotary drilling operations, a drilling fluid or mud is pumped from the surface down the drill string through the BHA and the drill bit into an annulus between the drill string and the borehole wall and then returned to the surface along with cuttings from the formation. Oftentimes when drilling a borehole in a subsurface formation, it is desirable to drill some portion of the wellbore with a curvature or deviation to direct the borehole to a desired target. In such instances it is necessary for the drilling operator to be able to control or “steer” the direction of the drill bit. Additionally, some tools or systems use downhole telemetry to communicate with sensors or electronics on the BHA or other downhole components. Various types of tools and mechanisms exist to provide steering control and telemetry functionality.

### SUMMARY

Driving a valve located downhole in a steering tool presents significant challenges, particularly due to the high energy required to actuate the valve against hydraulic forces. These difficulties are further compounded when multiple valves are used for steering or telemetry, as the mechanical coupling and pressure management become more complex, often leading to expensive and complicated solutions to ensure reliable operation. The valve actuator may be required to overcome the full pressure differential across the valve, resulting in increased power consumption, reduced efficiency, and potential reliability issues.

Embodiments of the disclosure address these challenges by incorporating various force balancing features into a valve apparatus. In some embodiments, force balancing elements are coupled to the valve bodies and are fluidly connected to opposite chambers in the valve such that the hydraulic forces acting on the valve components are balanced, significantly reducing the energy required for actuation. A flow twisting section reorients fluid flow paths to provide pressure balancing, while additional valve bodies and shaped surfaces may provide additional force balancing functions. Embodiments of the disclosure thus provide a downhole valve apparatus that operates efficiently with lower power demand, improved reliability, and easier control of pressure differentials for both steering and mud pulse telemetry applications.

A system is provided for generating a differential pressure in a fluid passageway within a housing. The system includes a fluid passageway, a first valve member disposed in the fluid passageway, and a first flow restrictor guiding fluid to a first chamber. An actuator is configured to move the first valve member to restrict fluid flow through the first flow restrictor, thereby generating a first differential pressure across the fluid passageway. The system further includes a second valve member disposed in the fluid passageway and a second flow restrictor guiding fluid to a second chamber, with the second valve member movable by the actuator to restrict fluid flow through the second flow restrictor and generate a second differential pressure across the fluid passageway. A first force balancing component is mechanically connected to the first valve member and positioned in a first bore between the first chamber and a first channel, while a second force balancing component is mechanically connected to the second valve member and positioned in a second bore between the second chamber and a second channel. The first chamber is in fluid communication with the second channel by a first fluid connection, and the second chamber is in fluid communication with the first channel by a second fluid connection. A locomotive connection is provided between the first valve member and the second valve member.

The system may further include a first valve force acting on the first valve member in a first valve force direction and a second valve force acting on the second valve member in a second valve force direction, with the first differential pressure applying a first balancing force on the first balancing component and the second differential pressure applying a second balancing force on the second balancing component. The first balancing force acts in a direction opposite the first valve force direction, and the second balancing force acts in a direction opposite the second valve force direction. The first flow restrictor may be positioned at an upstream end of the first chamber, with the first bore at a downstream end of the first chamber, and the second flow restrictor at an upstream end of the second chamber, with the second bore at a downstream end of the second chamber.

In some embodiments, a biasing member may be provided in the first channel, with the first differential pressure extending the biasing member from an outer surface of the housing. The system may also include a first biasing member in the first channel and a second biasing member in the second channel, with the first differential pressure extending the first biasing member from the outer surface of the housing and the second differential pressure extending the second biasing member from the outer surface of the housing. The differential pressures generated by the system may be used to perform mud pulse telemetry.

The system may further include a first nozzle in the first channel and a second nozzle in the second channel, with the first nozzle having a first size and the second nozzle having a second size, and at least one of the nozzle sizes being adjustable. The first valve member may include a first valve body and the second valve member may include a second valve body, with at least one of the valve bodies having a shaped surface configured to increase the respective valve force. The fluid flow through the first chamber may have a flow direction, and the first fluid connection may reorient the flow direction when fluid flows from the first chamber into the second channel. The first force balancing component may include a pressure affected area selected to balance the first valve force, and the first and second balancing components may be pistons.

A method is also provided for generating a differential pressure in a fluid passageway in a housing. The method includes actuating a system between a first position to generate a first pressure differential across the fluid passageway and a second position to generate a second pressure differential across the fluid passageway. The method includes providing a fluid passageway, a first valve member, a first flow restrictor guiding fluid to a first chamber, an actuator configured to move the first valve member to restrict fluid flow through the first flow restrictor, a second valve member, a second flow restrictor guiding fluid to a second chamber, the second valve member movable by the actuator to restrict fluid flow through the second flow restrictor, a first force balancing component mechanically connected to the first valve member and positioned in a first bore between the first chamber and a first channel, a second force balancing component mechanically connected to the second valve member and positioned in a second bore between the second chamber and a second channel, the first chamber in fluid communication with the second channel by a first fluid connection, the second chamber in fluid communication with the first channel by a second fluid connection, and a locomotive connection between the first valve member and the second valve member.

The method may further include a first valve force acting on the first valve member in a first valve force direction and a second valve force acting on the second valve member in a second valve force direction, with the first differential pressure applying a first balancing force on the first balancing component and the second differential pressure applying a second balancing force on the second balancing component, such that the first balancing force acts in a direction opposite the first valve force direction and the second balancing force acts in a direction opposite the second valve force direction. The method may include providing a biasing member in the first channel, with the first differential pressure extending the biasing member from an outer surface of the housing, or providing a first biasing member in the first channel and a second biasing member in the second channel, with the first differential pressure extending the first biasing member from the outer surface of the housing and the second differential pressure extending the second biasing member from the outer surface of the housing. The method may further include performing mud pulse telemetry using the first and second differential pressures.

The method may also include providing a first nozzle in the first channel and a second nozzle in the second channel, with the first nozzle having a first size and the second nozzle having a second size, and at least one of the nozzle sizes being adjustable. The first valve member may include a first valve body and the second valve member may include a second valve body, with at least one of the valve bodies having a shaped surface configured to increase the respective valve force. The fluid flow through the first chamber may have a flow direction, and the first fluid connection may reorient the flow direction when fluid flows from the first chamber into the second channel. The first force balancing component may include a pressure affected area selected to balance the first valve force.

### BRIEF DESCRIPTION OF THE DRAWINGS

FIG. 1 illustrates a partial cross-sectional view of a directional drilling system of an onshore well having a bottom hole assembly including a rotary steerable tool in accordance with an embodiment of the disclosure;

FIG. 2 is a schematic diagram of a force balanced dual valve apparatus in accordance with an embodiment of the disclosure.

FIG. 3 is a schematic diagram of a force balanced dual valve apparatus having differently located valve bodies than the embodiment of FIG. 2 in accordance with an embodiment of the disclosure;

FIG. 4A is a partial cross section of the flow twisting section of the force balanced dual valve apparatus having differently located valve bodies than the embodiment of FIG. 2 in accordance with an embodiment of the disclosure;

FIG. 4B is a schematic diagram of the fluid flow path in the flow twisting section of the force balanced dual valve apparatus in accordance with an embodiment of the disclosure;

FIG. 5A is a schematic diagram of a force balanced dual valve apparatus having additional valve bodies in accordance with an embodiment of the disclosure;

FIG. 5B is a schematic diagram of the force balanced dual valve apparatus of FIG. 5A with shaped surfaces of the valve bodies in accordance with another embodiment of the disclosure;

FIG. 6 is a schematic diagram of a valve body having a concave-shaped surface in accordance with an embodiment of the disclosure;

FIG. 7 is a schematic diagram of a force balanced dual valve apparatus without force balancing components and a flow twisting section in accordance with an embodiment of the disclosure; and.

FIGS. 8A and 8B are schematic diagrams of the forced balanced dual valve apparatus of FIG. 3 depicting actuation of biasing elements in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to a force balanced dual valve apparatus designed for use in downhole steering tools and mud pulse telemetry systems. The apparatus addresses the challenges associated with actuating valves under high hydraulic forces, which typically require significant energy and can compromise reliability and limits maximum valve actuation speed. Some embodiments include a flow twisting section that reorients fluid flow paths by approximately 180 degrees between an upstream valve section and a downhole steering pressure generation section to enable pressure balancing between valve bodies and force balancing pistons responsive to pressures in the pressure generation sections. Some embodiments may include additional valve bodies and shaped surfaces to provide further force balancing. Additionally, the flow twisting section may be omitted and the force balancing provided by valve bodies located in the valve section and steering pressure generation section.

Embodiment of the disclosure are capable of generating controlled pressure differentials (differential pressures) for steering applications, enabling precise directional control a drilling direction of a drill bit. Embodiments of the disclosure may also provide for mud pulse telemetry by actuating the dual valve apparatus to produce distinct pressure pulses in the drilling fluid for downhole data transmission from a downhole location to the earth surface. Embodiments are capable of generating controlled pressure differentials for steering applications while simultaneously using pressure differentials to generate pressure pulses configured to transmit data by mud pulse telemetry to the earth surface as described in U.S. Application Ser. No.63/728,551.

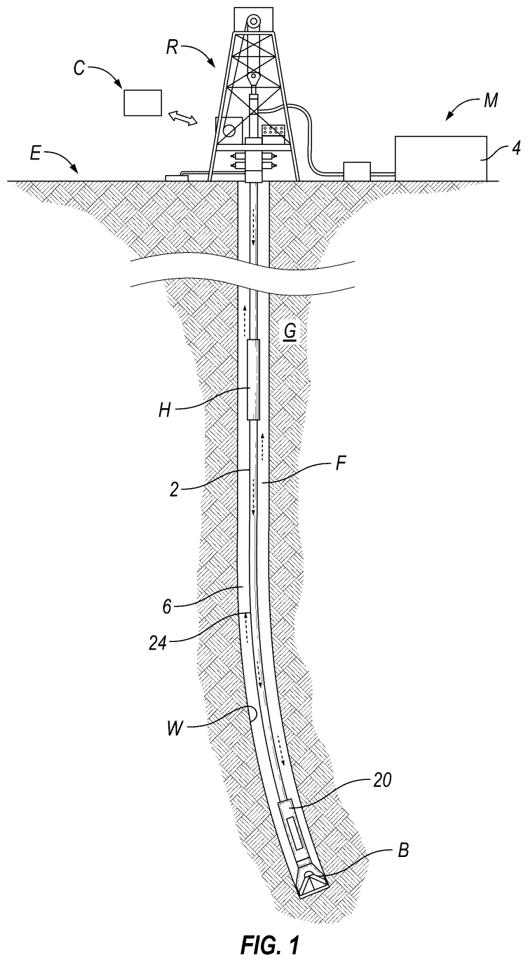

FIG. 1 depicts an elevation partial cross-sectional view of a typical onshore rotary well drilling system for forming a wellbore ore borehole H in a geological formation G in which the present disclosure may be utilized. The system includes a drilling rig R at the earth surface E connected to a drill string 2. A bottom hole assembly (BHA) 20 at the lower end of the drill string 2 is connected to a drill bit B. Typically, the drilling rig R supports, lowers, and rotates the drill string 2 and drill bit B. A drilling fluid (e.g., a drilling mud) system M delivers drilling fluid (e.g., drilling mud) F at the earth surface from a drilling fluid tank 4 into a fluid passageway or bore 24 of the drill string 2. The drilling fluid F is pumped down the bore 24 and through the BHA 20 and the drill bit B. The drilling fluid F exits the drill bit B and enters an annulus 6 between the drill string 2 or the BHA 20 and the borehole wall W of the borehole H and returns to the earth surface with cuttings from the borehole (arrows depicting flow of drilling fluid F down through the drill string 2 and up through the annulus 6). A surface data acquisition and control system C having a processor/controller is communicatively coupled to the BHA 20, including various downhole data acquisition tools and sensing devices. The surface data acquisition and control system C may communicate with the downhole devices in various manners. The communication means may be, for example, hardwired, fiber optic, or wireless. The BHA 20 may include various components and equipment, such as drill collars, stabilizers, reamers, shocks, hole-openers, logging-while-drilling (LWD) equipment, measurement-while-drilling (MWD) equipment, sensors, steering assemblies, and other downhole instruments. The sensors commonly include inclination and azimuth sensors, for example accelerometers, inclinometers, magnetometers, and rate gyros. Certain of the equipment, systems and techniques are used for gathering downhole data while drilling without needing to remove the drill string from the well. The BHA design can vary greatly depending on the complexity of the well. The BHA may include a force balanced dual valve apparatus or system in accordance with embodiments described herein.

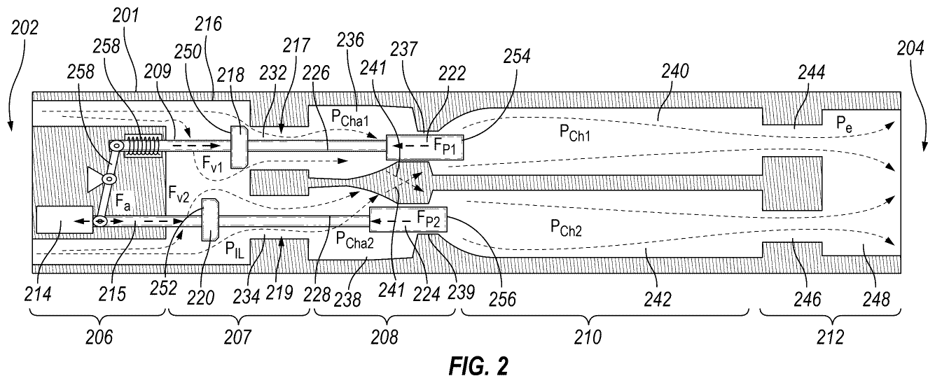

FIG. 2 shows a force balanced dual valve apparatus 200 that is oriented between an uphole or upstream side 202 and a downhole or downstream side 204 in accordance with an embodiment of the disclosure. The dual valve apparatus 200 is designed to generate a steering pressure differential or to generate a mud pulse telemetry pressure differential while minimizing the energy required to operate the valves. By integrating force balancing components and a flow twisting section, the dual valve apparatus 200 provides for hydraulic force balancing across the valves, which reduces the power demand on the actuator and enhances reliability and responsiveness.

As shown in FIG. 2, the force balanced dual valve apparatus 200 is disposed in a housing 201 (e.g., a tubular body of a steering tool) and includes the following sections and components: a valve actuator section 206, a valve section 207, a flow twisting section 208, a steering pressure generation section 210, and a flow restriction section 212. The operating components of the force balanced dual valve apparatus 200 include a first valve 211 and a second valve 213, a valve actuator 214, first valve member 217, and an inverse travel linkage 230. The first valve 211 includes a first flow restrictor 232 and a first valve member 217. The second valve 213 includes a second flow restrictor 234 and a second valve member 219. The first valve member 217 includes a first rod 209 and a first valve body 218. The second valve member 219 includes a second rod 215 and a second valve body 220. The inverse travel linkage 230 connects the first valve member 217 and the second valve member 219 by connecting the first rod 209 and the second rod 215. The first valve member 217 is connected to a first force balancing component (e.g., a piston 222) through a first valve linkage 226, and second valve member 219 is connected to a second force balancing component (e.g., a piston 224) through a second valve linkage 228. As shown in FIG. 2, the valve apparatus 200 includes various flow regions for the flow of a drilling fluid (e.g., a drilling mud): an inlet chamber 216 upstream of the first restrictor 232 and the second restrictor 234, a first chamber 236, a second chamber 238, a first channel 240, a second channel 242, and a fluid exit 248. The first channel 240 has a first nozzle 244 at a downstream end, the second channel 242 has a second nozzle 246 at a downstream end. The first nozzle 244 may also be referred to herein as first restricted outlet. The second nozzle 246 may also be referred to herein as second restricted outlet. In the embodiment depicted in FIG. 2, the fluid flowing into the dual valve (first valve 211, second valve 213) may exert fluid pressure on various surfaces, such as a first pressure affected area 250 of the first valve body 218, a second pressure affected area 252 of the second valve body 220, a third pressure affected area 254 of the first force balancing piston 222, and a fourth pressure affected area 256 of the second force balancing piston 224. The inverse travel linkage 230 may also be referred to herein as locomotive connection. The first and second force balancing pistons 222, 224 may also referred to herein as first and second piston 222, 224. The valve section 207 may also be referred to herein as the mud pulse generation section. Pressure differentials between the pressure P_{IL} in the inlet chamber 216 and the pressure P_{Cha1}, P_{Cha2} in the respective first and second chamber determine the pulse height (pulse strength) of a pressure pulse in a mud pulse telemetry pressure signal transmitted to the earth surface E.

The valve actuator 214 is positioned in the valve actuator section 206 and may be an electric-motor driven actuator responsible for driving the movement (that is, translation) of the valve bodies 218 and 220. The valve actuator 214 is mechanically coupled to the inverse travel linkage 230. The inverse travel linkage 230 ensures that translation of the first valve body 218 relative to the first flow restrictor 232 is mirrored by translation of the second valve body 220 relative to the second flow restrictor 234 in the opposite direction, enabling movement of the valve bodies 218 and 220 between valve open and valve closed positions. The valve actuator 214 applies an actuator force FA on the inverse travel linkage 230. The actuator toggles the inverse travel linkage between two opposite positions.

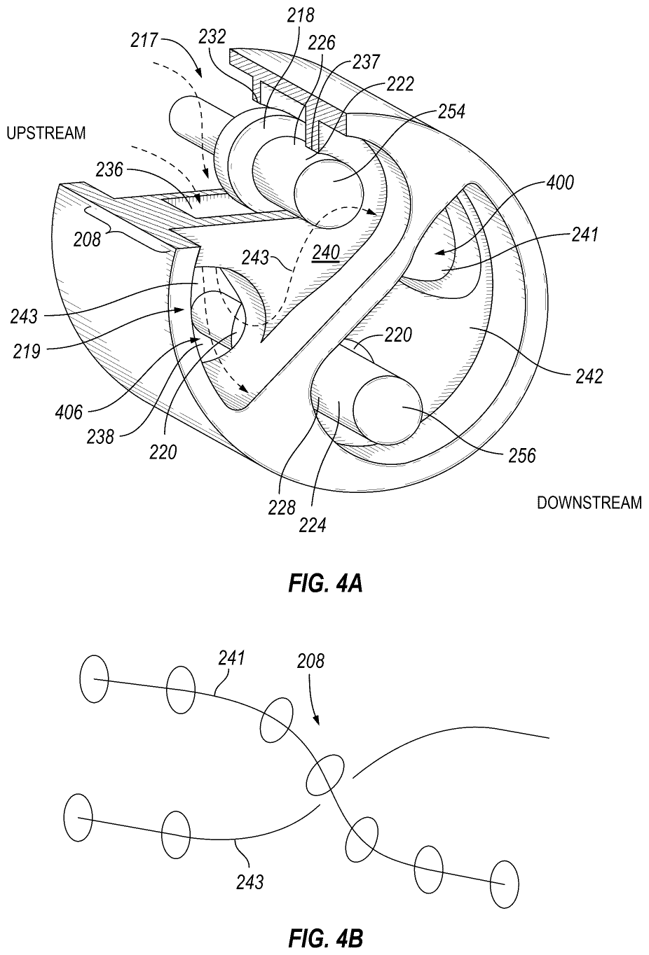

The first valve body 218 and the second valve body 220 are located within an inlet chamber 216 and are mechanically connected to the first valve linkage 226 and the second valve linkage 228, respectively. These first and second valve linkages 226 and 228 mechanically connect the valve bodies 218 and 220 and the first and second valve members 217, 219 to respective pistons 222 and 224. The first valve body 218 may restrict (“close”) or enable (“open”) flow through the first flow restrictor 232, while the second valve body 220 may restrict (“close”) or enable (“open”) flow through the second flow restrictor 234. In this manner, the flow of fluid through the force balanced dual valve apparatus 200 may be regulated for control of the desired pressure differential. As used herein, the “closing” of a flow restrictor does not require that all of the fluid is prevented from flowing through the flow restrictor. When a valve body closes a flow restrictor, substantially all of the fluid may flow through the other open flow restrictor; however, a small amount of fluid may flow through the closed flow restrictor. In an embodiment the valve bodies 218, 220 may directly be connected to the pistons 222, 224 as depicted in FIG. 4A. That is, the connection between the valve bodies 218, 220 and the pistons 220, 224 has the same diameter as the piston in its respective bore 237, 239 so that the respective valve body and piston merge. The first and second valve linkages 226, 228 appear to be a portion of the pistons 222, 224.

The first force balancing piston 222 is disposed in a first bore 237, such that that the first piston 222 blocks flow from the first chamber 236 into the first channel 240. Similarly, the second piston 224 is disposed and second bore 239, such that the second piston 224 blocks flow from the second chamber 238 into the second channel 242. The first valve linkage 226 is disposed in the first chamber 236 and second valve linkage 228 is disposed in the second chamber 238. The first bore 237 is located at a downstream end of the first chamber 236 and between the first chamber and the first channel 240. The second bore 239 is located at a downstream end of the second chamber 238 and between the second chamber and the second channel 240. The first and second bore can be cylindrically shaped with a circular cross-section. In an embodiment the first and second bore 237, 239 may be an opening with a cross-section different to a circular cross-section (e.g., elliptical, squared, or triangular, or any other suited cross-section). In this embodiment the first and second force balancing components are respectively shaped and have cross-sections different to a circular cross-section (e.g., elliptical, squared, or triangular, or any other suited cross-section).

The flow twisting section 208 fluidly connects the valve section 207 to the steering pressure generation section 210. The flow twisting section 208 reorients fluid flow paths by approximately 180° between the valve section 207 and the steering pressure generation section 210, such that fluid flow from the first chamber 236 is directed to the second channel 242 and fluid flow from the second chamber 238 is directed to the first channel 240, enabling improved force balancing between the forces acting on the first and second valve members 217, 219. The fluid flow paths in the flow twisting section 208 are illustrated by arrows 241 and 243 depicted in FIG. 2. Fluid from the first chamber 236 flows through the first fluid flow path of arrow 241 into second channel 242. Similarly, fluid from the second chamber 238 flows through the second fluid flow path of arrow 243 into first channel 240. The first fluid flow path 241 forms a first fluid connection between the first chamber 236 and the second channel 242. The second fluid flow path 243 forms a second fluid connection between the second chamber 238 and the first channel 240. The first chamber 236 has three openings: (1) the first restrictor 232, the first bore 237, and the first fluid connection for first fluid flow path 241. The first bore 237 is always closed by the first piston 222. In a valve configuration in which the first valve 211 is closed (first chamber 236 is closed) the first restrictor 232 is closed. The only opening open for fluid flow through first chamber 236 is the first fluid connection (first fluid flow path 241) to second channel 242. The second chamber 238 has three openings: (1) the second restrictor 234, the second bore 239, and the second fluid connection for second fluid flow path 243. The second bore 239 is always closed by the second piston 224. In a valve configuration in with the second valve 213 is closed (second chamber 238 is closed) the second restrictor 234 is closed. The only opening open for fluid flow through the second chamber 238 is the second fluid connection 243 to first channel 240. It is to be understood that although considered closed, little fluid flow is in general possible through a small first valve gap between first valve body 218 and first restrictor 232 in closed configuration, through a small first piston gap between the first piston 222 and an inner wall of the first bore 237, through a small second valve gap between second valve body 220 and second restrictor 234 in closed configuration, and through a small second piston gap between the second piston 224 and an inner wall of the second bore 239. The first fluid connection (first fluid flow paths 241) reorients the fluid flow on the way from the first chamber 236 to the second channel 242. The second fluid connection (second fluid flow paths 243) reorients the fluid flow on the way from the second chamber 236 to the first channel 242. The reorientation of flow may be at least 30°, 50°, 90°, 150°, or 180°. The fluid flow through the first chamber and the second chamber may be parallel up the flow twisting section 208.

The steering pressure generation section 210 includes the first channel 240 and the second channel 242 each fluidly connected to the respective chambers 238 and 236 by the fluid flow paths of the flow twisting section 208. The first restricted outlet 244 and the second restricted outlet 246 are positioned downstream of the first and second chambers 240, 242 leading to the fluid exit 248 and recirculation of the drilling fluid to the earth surface after it has passed the drill bit B. The pressure differential between channels 240 and 242 may enable the control of steering components, such as biasing members (e.g., steering pistons, steering balls, steering pads, or steering ribs) suitably positioned on the exterior of the steering pressure generation section 210 and responsive to pressures in the channels 240 and 242. The pressure in the first channel 240 is P_{Ch1}, the pressure in second channel 242 is P_{Ch2}. The differential pressure between the first channel 240 and the second channel 242 is P_{Ch1,Ch2}.

Force balancing is achieved through operation of the first piston 222 and the second piston 224 in response to fluid pressure as directed by the flow twisting section 208. The first valve body 218 is responsive to fluid pressure in the inlet chamber 216 acting on the first pressure affected area 250, and the second valve body 220 is response to fluid pressure in the inlet chamber 216 acting on the second pressure affected area 252. The first piston 222 is coupled to the first valve body 218 and is responsive to fluid pressure in the first channel 240 acting on the fourth pressure affected area 254. The second piston 224 is coupled to the second valve body 220 and is responsive to fluid pressure in the second channel 242 acting on the fourth pressure affected area 256. Thus, the fluid pressure on a piston 222 or 224 counteracts hydraulic forces acting on its respective valve body 218 or 220, reducing the energy required to operate the valve apparatus 200. The fluid pressure acting on the first valve body 218 results in first valve force F_{V1}. The fluid pressure acting on the second valve body 220 results in second valve force F_{V2}. The pressure acting on first piston 222 results in first piston force F_{P1}. The pressure acting on second piston 224 results in second piston force F_{P2}. The first and second piston force is also referred to herein as first and second balancing component force or fist and second balancing force.

Thus, the flow twisting section 208 enables the balancing of the fluid pressures across the respective chambers 236, 238: the piston 222 is affected by the pressure in the first channel 240 which is equalized to the pressure in the second chamber 238 via second fluid flow path 243. In the same manner, the piston 224 is affected by the pressure in the second channel 242 which is equalized to the pressure in the second chamber 236 via first fluid flow path 241. When valve body 220 is in unrestricting position relative to second flow restrictor 234 (second valve 213 in open position) the fluid pressure in the second chamber 238 is equalized with the fluid pressure in the inlet chamber 216.

As shown in the position illustrated in FIG. 2, if the valve body 218 is closed substantially all the fluid flow is primarily through flow restrictor 234, into chamber 238, and then into channel 240, such that the pressure affected area 254 of the first piston 222 is affected by the relatively high pressure generated by the closing the first valve 211 by valve body 218 restricting the first flow restrictor 232. Depending on the size of the pressure affected area 254, the ratio of force of the pressure affected area 250 of the valve body 218 may be equalized via the connection by the first valve linkage 226. The pressure P_{Ch1} in the first channel 240 is greater than the pressure P_{Ch2} in the second channel 242 when the pressure P_{Cha2} in the second chamber 238 is greater than the pressure P_{Cha1} in the first chamber 236. This is the case when the second flow restrictor 234 is unrestricted by the second valve body 220 and the first flow restrictor 232 is restricted by the first valve body 218. The pressure P_{Cha2} in the second chamber 238 is then nearly the same as the pressure P_{IL} in the inlet chamber 216. Valve body 218 restricts fluid flow through first flow restrictor 232 leading to a great differential pressure P_{IL,Cha1} between the inlet chamber 216 and the first chamber 236. Fluid flow through second flow restrictor 234 is unrestricted leading to a small differential pressure P_{IL,Cha2} between the inlet chamber 216 and the second chamber 236. The differential pressure P_{IL,Cha2} is much smaller than differential pressure P_{IL,Cha1}. The differential pressure P_{Cha2,Ch1} between the second chamber 238 and the first channel 240 is small and only determined by a cross section of a fluid connection forming second fluid flow path 243 in flow twisting section 208. The first channel 240 is in fluid communication with the second chamber 238 and the inlet chamber 216 through second fluid flow path 243 in fluid twisting section 208. In a first approximation and for the sake of simplification the pressure P_{Ch1} in the first channel 240 is the same as the pressure P_{IL} in the inlet chamber 216 and the differential pressure (P_{Ch1,Ch2}) between the first channel 240 and the second channel 242 is the same as the differential pressure (P_{IL,Cha1}) between the inlet chamber 216 and the first chamber 236. The differential pressure (P_{Ch1,Ch2}) is the same as the differential pressure (P_{Cha1,Cha2}) between the first chamber 236 and the second chamber 238. The fluid communication between the inlet chamber 216 and the first channel 240 leads to a large pressure in the first channel and to a first piston force F_{P1} on the first piston 222. The first piston force F_{P1} (due to the pressure P_{Ch1} in the first channel 240) and the first valve force F_{V1} on the first valve body 218 (due to the pressure P_{IL} in inlet chamber 216) are oriented in opposite directions canceling out each other at least partially, or balancing each other, depending on the sizes of the pressure affected areas 250 and 254. The second valve body 220 and second piston 224 may operate in a similar manner when in the opposite position in which the second valve body 220 restricts fluid flow through flow restrictor 234 (second valve 213 in closed position and first valve 211 in open position). The pressure P_{Ch2} in the second channel 242 is greater than the pressure P_{Ch1} in the first channel 240 when the pressure P_{Cha1} in the first chamber 236 is greater than the pressure P_{Cha2} in the second chamber 238. This is the case when the first flow restrictor 232 is unrestricted by the first valve body 218 and the second flow restrictor 234 is restricted by the second valve body 220. The pressure P_{Cha1} in the first chamber 236 is then nearly the same as the pressure P_{IL} in the inlet chamber 216. Second valve body 220 restricts fluid flow through second flow restrictor 234 leading to a large differential pressure P_{IL,Cha2} between the inlet chamber 216 and the second chamber 238. Fluid flow through first flow restrictor 232 is unrestricted leading to a small differential pressure P_{IL,Cha1} between the inlet chamber 216 and the first chamber 236. The differential pressure P_{IL,Cha1} is much smaller than differential pressure P_{IL,Cha2}. The differential pressure P_{Cha1, Ch2} between the first chamber 236 and the second channel 242 is small and only determined by a cross section of a fluid connection forming first fluid flow path 241 in flow twisting section 208. The second channel 242 is in fluid communication with the first chamber 236 and the inlet chamber 216 through first fluid flow path 241 in fluid twisting section 208. In a first approximation and for the sake of simplification the pressure P_{Ch2} in the second channel 242 is the same as the pressure P_{IL} in the inlet chamber 216 and the differential pressure (P_{Ch2,Ch1}) between the second channel 242 and the first channel 241 is the same as the differential pressure (P_{IL,Cha2}) between the inlet chamber 216 and the second chamber 238. The differential pressure (P_{Ch2,Ch1}) is the same as the differential pressure (P_{Cha2,Cha1}) between the second chamber 238 and the first chamber 236. The fluid communication between the inlet chamber 216 and the second channel 242 leads to a great pressure in the second channel and to a second piston force F_{P2} on the second piston 224. The second piston force F_{P2} (due to the pressure P_{Ch2} in the second channel 242) and the second valve force F_{V2} on the second valve body 220 (due to the pressure P_{IL} in inlet chamber 216) are oriented in opposite directions canceling out each other at least partially, or balancing each other, depending on the sizes of the pressure affected areas 252 and 256. The pressure difference P_{Ch1,Ch2} between the pressures in the first channel 240 and the second channel 242, which is generated if one valve body is nearly closed depends on the size of the restricted outlets 244 and 246 (nozzles) relative to the flow rate of the fluid. If both valve bodies 218 and 220 are open, the total flow of fluid is through both restricted outlets 244 and 246 and a base pressure drop is generated. If one valve body 218 or 220 is closed, the fluid flows through one of the restricted outlets 244 or 246. Consequently, the flow area is half of the area in the fully open position, which results in a larger pressure drop relative to the base pressure in the fully open position. The size (flow cross section) of the nozzles 244 and 246 are adjustable to adapt to variations in fluid properties, such as flow rate and fluid density. The adjustment of the nozzles 244, 246 may be performed by exchanging the whole nozzles by nozzles with a different size. The size of the nozzles 244 and 246 may be the same or may differ from each other. In an alternative embodiment the size of the nozzles 244, 246 may be adjusted by placing a size reducing member (not shown) inside the nozzle(s) or be removing a size reducing member from the nozzle(s). A size reducing member may be a pin that is moved into the nozzle(s), for example by moving a pin oriented perpendicular to the flow direction into the nozzle.

An alternate embodiment of the valve apparatus may incorporate springs positioned on the first valve linkage 226 and the second valve linkage 228, or alternatively, further upstream on the valve (e.g., between the valve bodies 218 and 220 and the actuator section 206). In this configuration, the springs are arranged to generate additional compression forces that contribute to the overall force balancing of the valve system. The springs may be selected and positioned such that they bias the respective valve bodies toward either an open or closed position, depending on the desired operational characteristics. For example, a spring disposed on the first valve linkage 226 may exert a force that opposes the hydraulic pressure acting on the first valve body 218 via pressure affected area 250, thereby assisting in maintaining a balanced force across the valve body during operation. Similarly, a spring on the second valve linkage 228 may be configured to counteract the hydraulic forces acting on the second valve body 220, supporting the force balancing mechanism and reducing the energy required to actuate the valve.

Alternatively, a neutralizing spring 258 may be positioned on the first rod 209 or the second rod 215, such as adjacent to the valve actuator section 206. The neutralizing spring 258 is configured to generate a neutralizing spring force when one of the first valve 211 or second valve 213 is in closed position. In this arrangement, the spring can provide a restoring force (neutralizing spring force) that acts on the inverse travel linkage 230, ensuring that both valve bodies 218 and 220 are biased toward a neutral or open position when the actuator 214 is not engaged. In case the valve actuator 214 fails or power supply is interrupted in the BHA 20 the neutralizing spring 258 ensures a default position of the dual valve system 200 is an open position (first valve 211 and second valve open 213). This way fluid flow through the forced balanced dual valve apparatus 200 is guaranteed and the circulation of fluid flow though the BHA and borehole is maintained. The neutralizing spring force pulls or pushes (depending on the configuration) the two valve members 217, 219 to a middle position (inverse travel linkage 230 in a leveled position and both valve bodies at the same distance to the respective flow restrictor 232, 234).

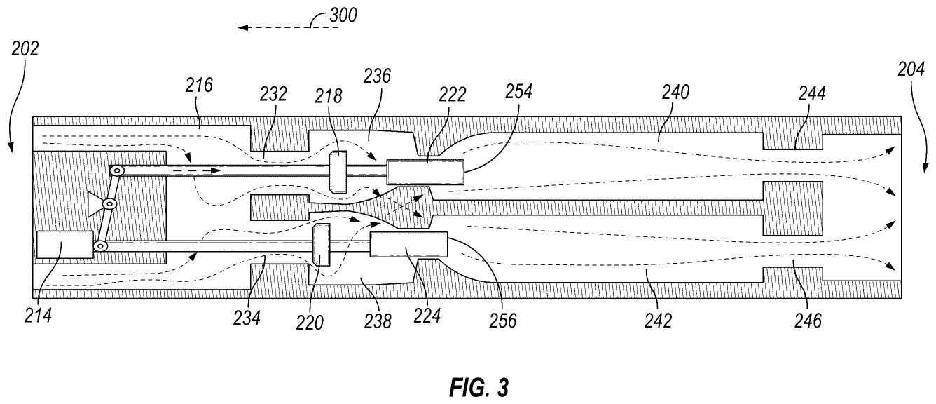

In some embodiments, first and second valve bodies may be located downstream from the valve section 207, and downstream from the flow restrictors 232, 234. FIG. 3 depicts another embodiment of the force balanced dual valve apparatus 200 in which the valve bodies 218 and 220 are located in the first chamber 236 and second chamber 238, respectively. In the embodiment depicted in FIG. 3, restriction of one of the flow restrictors 232 or 234 is accomplished by translation of a respective first and second valve body 218 or 220 in an upstream direction indicated by arrow 300. For example, in the position shown in FIG. 3, the second valve body 220 is restricting the second restrictor 234 such that substantially all fluid flow is through flow restrictor 232, into first chamber 236, and then into second channel 242 via the first fluid flow path 241 in fluid twisting section 208. In this position, the pressure affected area 256 of the second piston 224 is affected by the pressure generated in the first chamber 236 and fluidly connected to the second channel 242. The pressure in the first chamber 236 is equalized with the pressure in the inlet chamber 216 and is larger than the pressure in the second chamber 238. Thus, the embodiment depicted in FIG. 3 may operate in a similar manner to the embodiment described supra, with the valve bodies 218 and 220 restricting or closing the chambers 238 and 240 from the downstream side of the flow restrictors 232 and 234.

FIG. 4A depicts an embodiment of a portion of the flow twisting section 208 illustrating the first and second fluid flow paths 241 and 243 that fluidly connect the chambers and channels of the valve apparatus 200. It should be appreciated that the embodiment of FIG. 4A is an example embodiment and other fluid flow paths designs may be used. FIG. 4A depicts the first piston 222 disposed in the first bore 237, and the first valve body 218 disposed downstream of the first flow restrictor 232. The first valve member 217 with first valve body 218 is connected to the first piston 222 by first valve linkage 226. FIG. 4A shows the first flow restrictor 232 restricted by first valve body 218 (first valve 211 closed) such that the first chamber 236 is closed to fluid flow. FIG. 4A also depicts the second piston 224 disposed in the second bore 239, and second valve body 220 connected to the second piston 224, the second valve body disposed downstream the second flow restrictor 234, such that the second chamber 238 is open for fluid flow.

The flow twisting section 208 reorients fluid flow paths by approximately 180°, facilitating pressure balancing between the second chamber 238 and the first channel 240 or pressure balancing between the first chamber 236 and the second channel 242, depending on which of the first restrictor 232 and the second restrictor 234 is closed. As shown in FIG. 4A, a fluid connection 400 between the first chamber 236 fluidly connects the second channel 242. The second channel 242 having the pressure affected area 256 of second piston 224. Fluid may flow via the twisted path (241) from first chamber 236 and through fluid connection 400 into the second channel 242. Thus, pressure from the first chamber 236 may enter the second channel 242 and exert against the pressure affected area 256 of first piston 224. Similarly, as indicated by arrow 243, fluid from the second chamber 238 may flow from the second chamber 238 and through fluid connection 406 into the first channel 240. Thus, fluid pressure from the second chamber 238 may enter the first channel 240 and exert against the pressure affected area 254 of first piston 222. The fluid flow paths or fluid connections 400 and 406 may be any suitable shape and cross section (e.g., cylindrical or elliptical) that enables formation of the fluid flow paths in the flow twisting section 208. FIG. 4A illustrates a valve configuration in which the second valve 213 is open. Second valve body 220 is in an unrestricted position relative to the second restrictor 234. Fluid flows through the second restrictor 234 (not visible) into second chamber 238 and from there through fluid connection 406 (second fluid flow path 243) into the first channel 240.

FIG. 4B is a schematic diagram of fluid flow paths in the flow twisting section 208 of the force balanced dual valve apparatus 200 in accordance with an embodiment of the disclosure. The first fluid flow path 241 depicts the flow path from the first chamber 236 and through fluid connection 400 into the second channel 242. The second fluid flow path 243 depicted in FIG. 4B illustrates the flow path from the second chamber 238 and through fluid connection 406 into the first channel 240. There is no fluid connection from the first chamber 236 to the first channel 240. There is no fluid connection from the second chamber 238 to the second channel 242. There is no fluid communication between first chamber 236 and first channel 240. There is no fluid communication between the second chamber 238 and the second channel 242. No fluid flows from the first chamber 236 to the first channel 240 and no fluid flows from the second chamber 238 to the second channel 242.

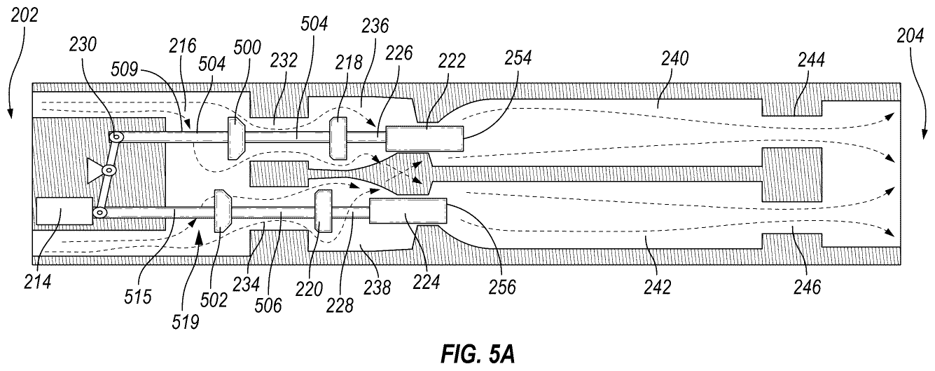

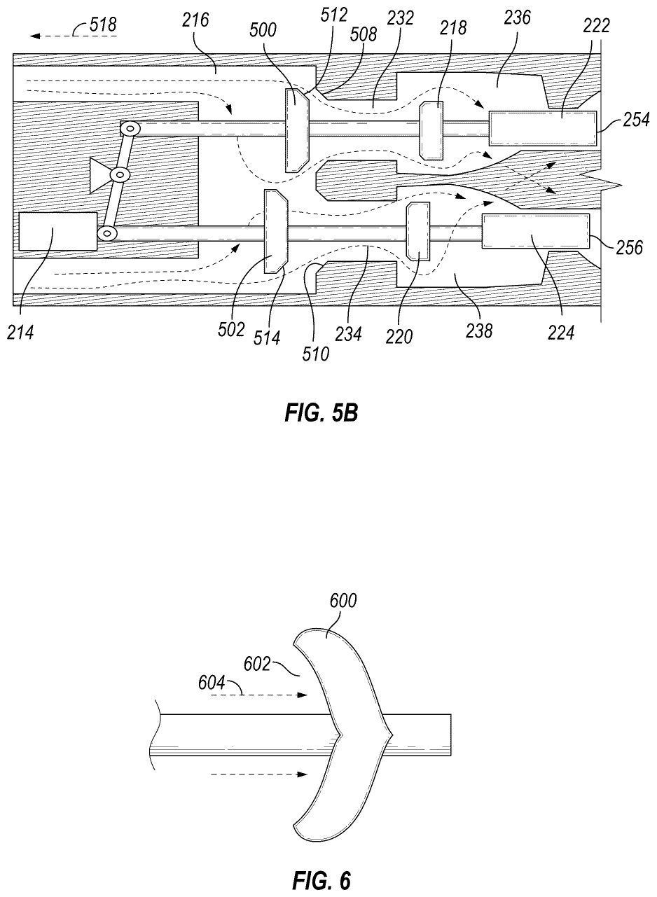

FIG. 5 shows an alternative embodiment of the valve apparatus 200 in which a first valve member 517 has a third valve body 500 and second valve member 519 has a fourth valve body 502. Third valve body 500 and fourth valve body 502 are located in the inlet chamber 216, with the first and second valve bodies 218 and 220 positioned in the respective first and second chambers 236 and 238. As shown in FIG. 5, the valve actuator 214 is mechanically coupled to a first valve member 517 and a second valve member 519 with third and fourth valve bodies 500, 502 and first and second valve bodies 218, 220 via the inverse travel linkage 230. The third and fourth valve bodies 500 and 502 are coupled to the first and second valve bodies 218 and 220 respectively via a first valve body linkage 504 which forms a portion of the first valve member 517 and a second valve body linkage 506 which forms a portion of the second valve member 519. First valve member 517 in FIG. 5A includes the first rod 509, the first valve body 218, the third valve body 500 and a first valve body linkage 504. Second valve member 519 in FIG. 5A includes the second rod 515, the second valve body 220, the fourth valve body 502 and a second valve body linkage 506.

The third and fourth valve bodies 500 and 502 are arranged upstream from the first flow restrictor 232 and the second flow restrictor 234, respectively. These third and fourth valve bodies provide increased flow reducing capability through restrictors 232 and 234 respectively relative to the downstream side of the restrictor affected by first and second valve bodies 218 and 220. For example, as second valve body 220 translates to close second flow restrictor 234, the third valve body 500 translates (via inverse valve linkage 230) to further restrict fluid flow in flow restrictor 232. This additional restriction in the valve section 207 (FIG. 2) results in an increased pressure in the valve actuator section 206 or the inlet chamber 216, resulting in an increased pressure differential P_{IL,E} between the inlet chamber 216 and the fluid exit 248. In turn the increased pressure differential P_{Ch1,Ch2} comes with a stronger pressure increase or stronger pressure pulse in the inlet chamber 216 (P_{IL}). The stronger pressure pulse facilitates mud pulse telemetry with the earth surface.

Additionally, in some embodiments the downstream surfaces of the third and fourth valve bodies 500 and 502 may be configured to shape the force balance characteristics relative to the position of the third and fourth valve bodies 500 and 502. As shown in FIG. 5B, the surfaces 508 and 510 (valve seats) of the upstream side of the flow restrictors 232 and 234 may also be configured to match with the surfaces 512 and 514 of the third and fourth valve bodies 500 and 502 and further modify the force balance characteristics. For example, a closing force is generated by the fluid flow if the second and fourth valve bodies 220 and 502 translate in the direction indicated by arrow 518. This force depends on the flow velocity and the distance between the surfaces 508 and 512. In this example, the force generated on the third valve body 500 supports the balancing force generated on pressure affected area 256 of piston 224 and results in a relatively reduced pressure on these components in comparison to the significantly larger pressure differential across the channels 240 and 242 of the steering pressure generation section 210.

In some embodiments, the upstream surfaces of the valve bodies 218 and 220 may also be designed to achieve further force balancing. For example, in such embodiments the upstream surface area of the valve body 218 may be sized to more closely match the surface area of the pressure affected area 256 of the piston 224. Similarly, the upstream surface area of the valve body 220 may be sized to more closely match the surface area of the pressure affected face 254 of the piston 222.

In some embodiments, the shape of the areas 250 and 252 (FIG. 2) of the valve bodies 218 and 220 may be designed to generate a larger impact when fluid hits the areas. By way of example, FIG. 6 depicts a valve body 600 having a “parachute”-shaped (that is, concave-shaped) pressure affected area 602. The area 602 may result in a relatively larger impact when contacted by pressurized fluid compared to a rather planar shaped area as shown in FIG. 5B. The arrow 604 indicating the direction and impact of fluid flow on the area 602 of valve body 600. The concave-shaped area 602 may be specifically dimensioned to amplify the impact of the fluid flow, resulting in a larger force exerted on the valve body 600. In contrast, in other embodiments the upstream surface of a valve body may be constructed to provide for a relatively smaller impact with smooth fluid flow over the valve body.

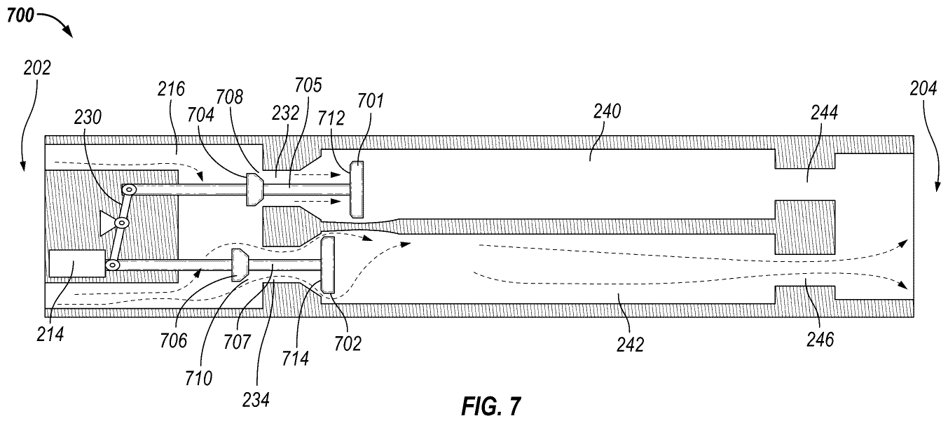

In some embodiments, a valve apparatus may omit the force balancing elements and the flow twisting section and solely rely on the valve bodies for force balancing functionality. FIG. 7 depicts a dual valve apparatus 700 for generating a steering pressure differential without force balancing elements in accordance with another embodiment of the disclosure. This embodiment integrates the force balancing mechanism directly into the valve bodies and associated components. The valve apparatus 700 omits the flow twisting section 208 but includes the other sections and flow areas described in the embodiments depicted in FIGS. 2, 3, 5 and 6.

As shown in FIG. 7, the dual valve apparatus 700 includes a first valve body 701 positioned in the first channel 240, a second valve body 702 positioned in the second channel 242, a third valve body 704 in the valve section 207 upstream from the first flow restrictor 232, a fourth valve body 706 in the valve section 207 upstream from the second restrictor 234, and shaped surfaces 708 and 710 on the additional valve bodies 704 and 706. FIG. 7 also depicts the valve actuator 214 and inverse travel linkage 230 that operate in the same manner as the other embodiments described supra. The valve body 701 is mechanically coupled to the third valve body 704 via a valve body linkage 705, and the valve body 702 is mechanically coupled to the fourth valve body 706 via valve body linkage 707.

The third valve body 704 operates within the valve section 207 to restrict flow through the first flow restrictor 232, while the fourth valve body 706 operates within the valve section 207 to restrict flow through the second flow restrictor 234. When one of the third and fourth valve bodies 704 or 706 substantially closes one flow restrictor 232 or 234, fluid flow is directed through the other flow restrictor 234 or 232, resulting in a higher pressure differential between the associated channels 240 or 242. In such an embodiment without force balancing elements, the force balance is affected by the area of the flow affected surfaces 712 and 714 of the first and second valve bodies 700 and 702 respectively, the shapes of the third and fourth valve bodies 704 and 706, and the shape of the mating surfaces 708 and 710 of the upstream valve bodies 704 and 706, particularly under relatively larger pressure differential conditions or nearly closed valve positions. For example, the surface area of the surfaces 712 and 714 and of the surfaces 708 and 710 may be designed to optimize the force balancing functionality of the valve apparatus 700. The third and fourth valve bodies 704 and 706 provide an extra reduction in the cross-sectional area of the flow restrictors 232 and 234, further enhancing the pressure differential between the 240 and 242.

Any of the valve apparatus embodiments described supra and illustrated in FIGS. 2-7 may be used to control a steering system having steering members (e.g., pistons) actuated by the pressure differential across the channels 240 and channels 242, such as described in U.S. Provisional Patent Application Ser. No. 63/828,551 filed on Dec. 5, 2024, titled “Mud Hydraulic Operated Rotary Steerable System,” now PCT Application No. ______ filed on Dec. 5, 2025, each of which are incorporated by reference in their entirety.

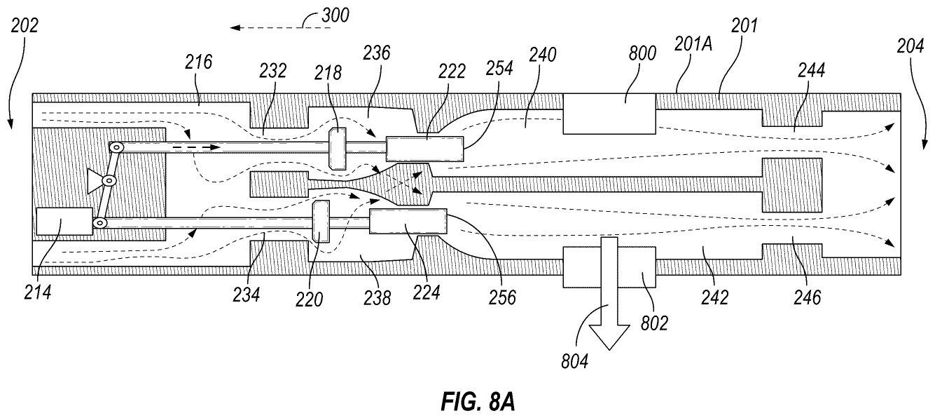

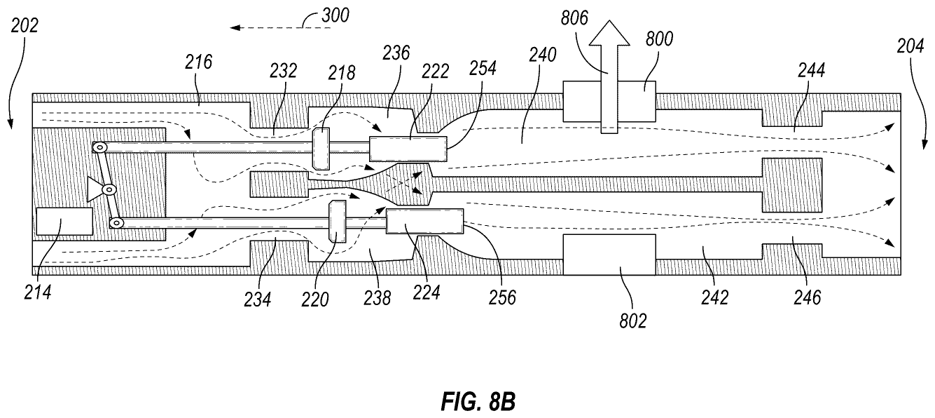

By way of example, FIGS. 8A and 8B are schematic diagrams of the valve apparatus of FIG. 3 depicting actuation of a first biasing member 800 and a second biasing member 802 in accordance with an embodiment of the disclosure. In FIG. 8A the first and second biasing member 800 and 802 are not mechanically coupled by a connecting rod or other mechanism and are allowed to move independently of each other in response to a pressure differential between the channels 240 and 242. When activated by an increase in differential pressure between first channel 240 and second channel 242 one of the first and second biasing members 800 or 802 are extended from an outer surface 201A of housing 201 while the other biasing member 802 or 800 is retracted from an extended position and from engaging with the borehole wall W due to the lower pressure in the second channel 242. The extended biasing member engages with the borehole wall W and pushes the BHA with the drill bit B to the opposite side of the borehole, steering the drill bit to a desired direction. In such embodiments, retraction of the first and second biasing members 800 and 802 does not automatically occur upon a decrease in fluid pressure in the channels 240 and 242 but may occur due to forces generated by contact with the borehole wall (e.g., borehole wall W of FIG. 1) or may be pulled back into the housing 201 by springs. The biasing members 800 and 802 may be a steering piston.

For example, as shown in FIG. 8A, in this position the dual valve apparatus 200 causes a greater pressure in second channel 242 than in first channel 240, causing the second steering piston 802 to extend radially in the direction indicated by arrow 804. As shown in FIG. 8B, when the valve actuator 214 translates the first valve body 218 from an unrestricted position relative to flow restrictor 232 (first valve 211 in open position) to an restricted position relative to first flow restrictor 232 (first valve 211 in closed position) (while concurrently translating the second valve body 220 from the restricted position relative to second flow restrictor 234 (second valve 213 in closed position) to the unrestricted position relative to second flow restrictor 234 (second valve 213 in open position), the pressure in the second channel 242 decreases while the pressure in the first channel 240 increases, causing the first steering piston 800 to extend radially in the direction indicated by arrow 806. With the decrease of pressure in the second channel 242, the second steering piston 802 may move radially inward, for example, if it comes into contact with a borehole wall W Thus, without the first and second steering pistons 800 and 802 being coupled to one another, the steering force is calculated by the force difference of the two opposing steering pistons 800 and 802 acting against the borehole wall W in opposite directions.

The valve apparatus embodiments described in the disclosure may also be used for mud pulse telemetry by utilizing its ability to generate controlled pressure differentials within the drilling fluid flow and within inlet chamber 216. In mud pulse telemetry systems, information is transmitted from downhole tools to the earth surface E by creating pressure pulses in the drilling mud. These pulses are detected at the surface and decoded to retrieve data about downhole conditions. The force balancing capability of the dual valve apparatus embodiments allows precise and efficient control of the valve bodies, which may be actuated to rapidly open and close the flow restrictors. By selectively restricting and enabling fluid flow through flow restrictors, a dual valve apparatus may generate distinct pressure pulses in the drilling fluid. Additionally, a dual valve apparatus may be operated to modulate the amplitude and frequency of the pressure pulses by adjusting the travel and timing of the valve bodies. This flexibility allows the system to encode various types of data for transmission to the surface as described in U.S. Application Ser. No. 63/728,551 and U.S. Pat. No. 11,892,093 each of which are incorporated herein by reference in their entirety. Thus, the force balancing capability and pressure differential control of the valve apparatus described herein make it applicable in both steering control and mud pulse telemetry applications.

It is to be appreciated that in the disclosed dual valve apparatus 200 the majority (up to 100%) of the fluid flow pumped downhole through the fluid passage or inner bore 24 passes through the first valve 211 and the second valve 213 and through the first channel 240 and the second channel 242. The first and second channel 240, 242 may be dimensioned equally leading to the same fluid flow rate in the first channel 240 as in the second channel 242 when the respective valve is in an open position. In an embodiment the valve apparatus may have a small bypass channel that allows some fluid to bypass the sections 207, 208, 209, 210, and 212. In one embodiment the bypass channel may be located in the housing 201. The bypass channel may allow in maximum 1%, 5%, 10%, 30%, or 50% of the fluid flow from the fluid passage not to go through first and second valves 218, 220 and first and second channel 240, 242.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

1. A system to generate a differential pressure in a fluid passageway in a housing, the system comprising:
a fluid passageway;
a first valve member disposed in the fluid passageway;
a first flow restrictor in the fluid passageway guiding to a first chamber;
an actuator configured to move the first valve member to restrict a fluid flow through the first flow restrictor to generate a first differential pressure across the fluid passageway;
a second valve member disposed in the fluid passageway;
a second flow restrictor in the fluid passageway guiding to a second chamber,
the second valve member movable by the actuator to restrict a fluid flow through the second flow restrictor to generate a second differential pressure across the fluid passageway;
a first force balancing component mechanically connected to the first valve member, the first force balancing component in a first bore between the first chamber and a first channel;
a second force balancing component mechanically connected to the second valve member, the second force balancing component in a second bore between the second chamber and a second channel:
the first chamber in fluid communication with the second channel by a first fluid connection;
the second chamber in fluid communication with the first channel by a second fluid connection; and
a locomotive connection between the first valve member and the second valve member.

2. The system of claim 1, further comprising a first valve force acting on the first valve member in a first valve force direction, and a second valve force acting on the second valve member in a second valve force direction, the first differential pressure applies a first balancing force on the first balancing component and the second differential pressure applies a second balancing force on the second balancing component, wherein the first balancing force acts in a direction opposite the first valve force direction and the second balancing force acts in a direction opposite the second valve force direction.

3. The system of claim 1, wherein the first flow restrictor at an upstream end of the first chamber, the first bore at a downstream end of the first chamber, the second flow restrictor at an upstream end of the second chamber, the second bore at a downstream end of the second chamber.

4. The system of claim 1, further comprising a biasing member in the first channel, the first differential pressure extends the biasing member from an outer surface of the housing.

5. The system of claim 1, further comprising a first biasing member in the first channel, and a second biasing member in the second channel, the first differential pressure extends the first biasing member from an outer surface of the housing, and the second differential pressure extends the second biasing member from the outer surface of the housing.

6. The system of claim 1, wherein the first differential pressure and the second differential pressure is used to perform mud pulse telemetry.

7. The system of claim 1, further comprising a first nozzle in the first channel and a second nozzle in the second channel, the first nozzle having a first size, the second nozzle having a second size, at least one of the first size or the second size adjustable.

8. The system of claim 1, wherein the first valve member includes a first valve body and the second valve member includes a second valve body, at least one of the first valve body or the second valve body have a shaped surface configured to increase the respective first or second valve force.

9. The system of claim 1, wherein the fluid flow through the first chamber has a flow direction, and the first fluid connection reorients the flow direction when the fluid flows from the first chamber into the second channel.

10. The system of claims 2-9 claim 1, wherein the first force balancing component comprises a pressure affected area, and the pressure affected area is selected to balance the first valve force.

11. The system of claim 1, wherein the first balancing component and the second balancing component are pistons.

12. A method of generating a differential pressure in a fluid passageway in a housing, the method comprising:
actuating a system between a first position to generate a first pressure differential across the fluid passageway of the system and a second position to generate a second pressure differential across the fluid passageway of the system, the system comprising:
the fluid passageway;
a first valve member disposed in the fluid passageway;
a first flow restrictor in the fluid passageway guiding to a first chamber;
an actuator configured to move the first valve member to restrict a fluid flow through the first flow restrictor to generate a first differential pressure across the fluid passageway;
a second valve member disposed in the fluid passageway;
a second flow restrictor in the fluid passageway guiding to a second chamber,
the second valve member movable by the actuator to restrict a fluid flow through the second flow restrictor to generate a second differential pressure across the fluid passageway;
a first force balancing component mechanically connected to the first valve member, the first force balancing component in a first bore between the first chamber and a first channel;
a second force balancing component mechanically connected to the second valve member, the second force balancing component in a second bore between the second chamber and a second channel:
the first chamber in fluid communication with the second channel by a first fluid connection;
the second chamber in fluid communication with the first channel by a second fluid connection; and
a locomotive connection between the first valve member and the second valve member.

13. The method of claim 12, further comprising a first valve force acting on the first valve member in a first valve force direction, and a second valve force acting on the second valve member in a second valve force direction, the first differential pressure applies a first balancing force on the first balancing component and the second differential pressure applies a second balancing force on the second balancing component, wherein the first balancing force acts in a direction opposite the first valve force direction and the second balancing force acts in a direction opposite the second valve force direction.

14. The method of claim 12, further comprising a biasing member in the first channel, the first differential pressure extends the biasing member from an outer surface of the housing.

15. The method of claim 12, further comprising a first biasing member in the first channel, and a second biasing member in the second channel, the first differential pressure extends the first biasing member from an outer surface of the housing, and the second differential pressure extends the second biasing member from the outer surface of the housing.

16. The method of claim 12, the method comprising performing mud pulse telemetry using the first differential pressure and the second differential pressure.

17. The method of claim 12, further comprising a first nozzle in the first channel and a second nozzle in the second channel, the first nozzle having a first size, the second nozzle having a second size, at least one of the first size and the second size adjustable.

18. The method of claim 12, wherein the first valve member includes a first valve body and the second valve member includes a second valve body, at least one of the first valve body or the second valve body have a shaped surface configured to increase the respective first or second valve force.

19. The method of claim 12, wherein the fluid flow through the first chamber has a flow direction, and the first fluid connection reorients the flow direction when the fluid flows from the first chamber into the second channel.

20. The method of claim 12, wherein the first force balancing component comprises a pressure affected area, and the pressure affected area is selected to balance the first valve force.
